(19) United States
(12) Patent Application Publication
(10) Pub. No.: US 2018/0187046 A1
(43) Pub. Date: Jul. 5, 2018

(54) Coating Agent Composition for Producing Peelable and Chemically-Resistant Coatings

(71) Applicant: Akzo Nobel Coatings International B.V., Arnhem (NL)

(72) Inventors: Christoph PIECHA, Stadland (DE); Dirk SEEGER, Oldenburg (DE); Dieter HOHNHOLZ, Gross Ippener (DE)

(21) Appl. No.: 15/738,683

(22) PCT Filed: Jun. 8, 2016
(86) PCT No.: PCT/EP2016/062968

§ 371 Date: Dec. 21, 2017

(30) Foreign Application Priority Data
Jul. 7, 2015 (EP) 15175724.2

(51) Int. Cl. C09D 175/08; C08K 7/28; C08K 3/40; C08G 18/48; C08G 18/61; C08G 18/22; C08G 18/32; C08G 18/38; C08G 18/76; C08G 18/66

(52) U.S. Cl. CPC C09D 175/08; C08K 7/28; C08K 3/40; C08G 18/4829; C08G 18/61; C08G 18/222; C08G 18/6685; C08G 18/3206; C08G 18/3893; C08G 18/7671; C08G 18/4845; C08G 18/4808; C08G 18/3237

(57) ABSTRACT

The invention relates to peelable and chemically resistant coatings for metal and plastic substrates, and to the coating agent compositions required to produce same. The invention also relates to a process for producing such coatings and to the use of the coating agent compositions to protectively coat metal and plastic substrates in the field of aircraft construction.

### FIELD OF THE INVENTION

The present invention relates to peelable and chemically resistant coatings for metal and plastic substrates, as well as to coating agent compositions required for their production. The present invention relates further to a process for producing such coatings and to the use of the coating agent compositions for the protective coating of metal and plastic substrates in the field of aircraft construction.

### PRIOR ART

In the field of aircraft construction, various metals and metal alloys are used as base materials for constructing the outer shells of aircraft. The individual components produced from these base materials must be adjustable to different thicknesses depending on their load-bearing capacity and the structure of the aircraft as a whole. In addition, the final weight of an aircraft plays a decisive role for the subsequent economic viability of the aircraft. For this reason considerable efforts are made, even in the construction phase of an aircraft, to enable the weight of an individual component to be reduced while its quality and stability are retained. Calculations have shown that, in many components, there is the potential to reduce the thickness of the component in specific segments without adversely affecting the load-bearing capacity or the structure. For this reason, there is very great potential to reduce the overall weight of an aircraft by selectively thinning out specific segments of a component.

Because of their outstanding properties, such as, for example, high strength and high corrosion resistance while at the same time being flexible, and their relatively low weight, aluminum components, or components made of aluminum alloys, are preferably used in aircraft construction.

On account of technical limitations, mechanical milling is not used to adjust the thickness of different segments of the components. Instead, chemical milling baths are used. These chemical milling baths can be alkaline or acidic. Alkaline milling baths are predominantly used. They contain from 5 to 35% strength NaOH solutions and have temperatures in the range of from 60 to 100° C. Milling processes in alkaline milling baths generally last from 4 to 6 hours. Milling baths that have an acid pH generally contain 32% strength nitric acid and the conventional milling times are approximately 30 minutes.

Milling is carried out by completely immersing the components to be processed in the milling baths. Because the entire component is immersed in the milling baths and is thereby completely covered with chemicals, regions that are not to be milled must be protected. This is carried out predominantly by means of coatings, which are applied to the component prior to the milling process. The components are thereby first coated completely and then the segments of the component that are to be milled are demasked.

The coating agent compositions hitherto known and used in practice for producing coatings for use in chemical milling baths are predominantly conventional coating agent compositions, as are disclosed, for example, in U.S. Pat. No. 3,661,840 or U.S. Pat. No. 3,544,400. These coating agent compositions comprise OH- or SH-modified polybutadiene, polyisocyanates or diamines having a relatively low non-volatile fraction of approximately from 20 to 40%. They have a high fraction of readily volatile solvents as well as a very high filler content, based on the non-volatile fraction. Phenol or epoxy resins can additionally be used in the coating agent composition for improving the adhesion of the coating.

The disadvantage of these coating agent compositions is a very high organic solvent fraction which, on account of the high volatility of the solvents, causes considerable emissions which, depending on the composition, can be toxic and/or involve an increased risk of fire. Furthermore, in order to achieve the necessary film thicknesses of the coating on the substrate, a multi-stage application process including a plurality of drying times is often necessary, as a result of which the whole process for producing the coatings is very time- and cost-intensive. Moreover, the resulting coatings exhibit major quality defects in the form of pinholes, popping and/or blisters, as a result of which adequate protection of the underlying substrate cannot be ensured.

Coating agent compositions having a low solvent fraction and a high solids content have already been described in the literature. For example, WO97/35932 discloses a “solventless two-component peelable lacquer for metal surfaces” as well as a process for the surface coating of metal parts, in particular aluminum parts, by means of that peelable lacquer. However, these “solventless” coating agent compositions likewise have a relatively high content of fillers, as a result of which their storage stability is greatly impaired. The coatings known from the prior art also have a pronounced tendency to subsurface migration, which can lead to uncontrolled detachment of the coatings from the substrate during the milling process. Coatings from the prior art exhibit uneven subsurface migration incursions, which are usually in the range of from 2 to 5 mm. A further problem of the coatings known from the prior art is the poor visibility of blade cuts, which makes it more difficult purposively to bring together cut edges.

### OBJECT OF THE PRESENT INVENTION

The object underlying the present invention was to eliminate the above-mentioned disadvantages of the prior art. There are to be provided in particular coating agent compositions which permit the production of a peelable and chemically resistant coating for metal and plastic substrates. These coating agent compositions are to have as low a fraction of solvents as possible, in order to keep solvent emission as low as possible from an ecological point of view. In addition, the coating agent compositions are to allow the necessary film thicknesses of the coating to be produced by means of a single-stage application process, so that a time- and cost-intensive multi-stage application process is not required. Furthermore, the coating agent compositions are to have improved storage stability.

The coatings produced from the coating agent compositions are to have improved quality in terms of the reduced occurrence of pinholes, popping and/or blisters, so that improved protection of the underlying substrate is ensured. In addition, the coatings are to have a reduced tendency to subsurface migration in chemical milling baths, so that there is no uncontrolled detachment of the coating from the substrate during the milling process. A further object of the present invention is to improve the visibility of blade cuts in order thus to facilitate the bringing together of cut edges.

### ACHIEVEMENT OF THE OBJECT

It has surprisingly been possible to achieve the objects underlying the present invention by providing a coating agent composition comprising at least one binder component A and at least one curing agent component B,
the binder component A containing
A1 at least one polyether polyol component of poly(oxyalkylene) glycol,
A2 at least one aromatic diamine,
A3 silicone elastomer particles and
A4 at least one polyurethane urea,
the curing agent component B containing
B1 at least one urethane-group-containing component containing unblocked isocyanate groups and
B2 at least one aromatic diisocyanate of methylene di(phenyl isocyanate),
wherein the curing agent component B has a content of unblocked isocyanate groups of from 10 to 30% by weight, and
   the solids content of the coating agent composition is greater than 95% by weight.

The coating agent compositions according to the invention contain at least one binder component A and at least one curing agent component B. Despite the chosen expressions “binder component A” and “curing agent component B”, the general term binder within the meaning of the present invention represents the non-volatile fraction (=solids) of the coating material without pigments and fillers. The binders therefore include, for example, also cross-linkers, as are contained, for example, in the curing agent component B, and additives such as, for example, wetting and/or dispersing agents, antifoams, flow additives, rheology additives or catalysts, provided that they are not volatile under the conditions for determining the binder content. The binder content of a coating agent is determined by the Soxhlet extraction process (ISO 13944:2012; November 2012).

The solids content of the coating agent composition is determined in accordance with ISO 3251:2008 by drying 1 g of the coating agent composition for 60 minutes at 105° C. The non-volatile fraction that remains after drying is set in relation to the original weighed amount and gives the percentage solids content of the coating agent composition.

According to the invention, the solids content of the coating agent compositions is greater than 95% by weight. Preferably, the solids content is greater than 97% by weight, particularly preferably greater than 98% by weight and most particularly preferably greater than 99% by weight.

The binder fraction in the solids content of the coating agent composition according to the invention is preferably from 80 to 98% by weight, particularly preferably from 85 to 95% by weight. If the binder fraction in the solids content is 100% by weight, this means that the solids content comprises neither pigments nor fillers.

The hydroxyl number (OH number) of the polymers used is determined in accordance with DIN EN ISO 4629.

The isocyanate group content of the polyisocyanates used is determined in accordance with DIN EN ISO 11909.

The indicated molecular weight of the polymers is the weight-average molecular weight M_{w}. The weight-average molecular weight is determined in accordance with DIN 55672-1:2007-08.

Unless otherwise indicated herein, all references to standards relate to the standard that is in force at the date of filing of the present invention.

All percentages and data relating to substance parameters in respect of the indicated components A and B and the components contained therein relate—as is conventional—to the particular component in question without an organic solvent fraction, unless expressly indicated otherwise. If, for example, a coating agent composition according to the invention contains 10% by weight of a commercial formulation of a polyether polyol which contains the polyether polyol in the form of a 50% by weight solution in a solvent, this means that the coating agent composition according to the invention contains 5% by weight of the polyether polyol (i.e. 50% by weight of 10% by weight). The solvent introduced via the commercial formulation thus is not a percentage constituent of the polyether polyol but is included in the fraction of the solvent.

### Binder Component A

The coating agent compositions according to the invention contain at least one binder component A, wherein the binder component A contains at least one polyether polyol component A1 of poly(oxyalkylene) glycol, at least one aromatic diamine A2, silicone elastomer particles A3 and at least one polyurethane urea A4.

### Polyether Polyol Component A1

The coating agent compositions according to the invention contain in binder component A at least one polyether polyol component A1 of poly(oxyalkylene) glycol. Poly(oxyalkylene) glycols of ethylene oxide and/or propylene oxide are preferably used. The polyether polyol component A1 of poly(oxyalkylene glycol) preferably contains at least one poly(oxyalkylene) glycol of ethylene oxide and/or propylene oxide.

In a particularly preferred embodiment, the polyether polyol component A1 contains at least one propoxylated polyethylene glycol A1.1, at least one polypropylene glycol A1.2 and at least one propoxylated trimethylolpropane A1.3. In this particularly preferred embodiment, the propoxylated polyethylene glycol A1.1 has a weight-average molecular weight M_{w} between 6,000 and 7,000 g/mol and the OH number of the polypropylene glycol A1.2 is between 25 and 35 mg KOH/g.

The polyether polyol component A1 preferably is present in the coating agent compositions according to the invention in an amount of from 8 to 76% by weight, particularly preferably in an amount of from 20 to 70% by weight, based on the total weight of the coating agent composition.

### Aromatic Diamine A2

The coating agent compositions according to the invention in binder component A contain at least one aromatic diamine A2.

The aromatic diamine A2 preferably is a mononuclear aromatic compound. The two amine groups of the aromatic diamine A2 preferably are each bonded directly to the aromatic compound. Preferably one, two, three or four of the remaining substitution positions of the mononuclear aromatic compound, particularly preferably exactly three of the remaining substitution positions, carry alkyl radicals. In a particularly preferred embodiment, the alkyl radicals are methyl radicals and/or ethyl radicals, and in a most particularly preferred embodiment the aromatic diamine A2 is 3,5-diethyltoluene-2,4-diamine and/or 3,5-diethyltoluene-2,6-diamine. Suitable aromatic diamines A2 are supplied by Aldrich, for example.

The aromatic diamine A2 preferably is present in the coating agent compositions according to the invention in an amount of from 1 to 8% by weight, particularly preferably in an amount of from 3 to 5% by weight, based on the total weight of the coating agent composition.

The at least one aromatic diamine A2 is used as a cross-linker in the coating agent compositions according to the invention. A reduction in the percent by weight fraction of the aromatic diamine A2 in the total weight of the coating agent composition leads to an impairment of the tear propagation resistance of the resulting coating. An increase in the percent by weight fraction of the aromatic diamine A2 in the total weight of the coating agent composition leads to reduced chemical resistance of the resulting coating and also to impaired processability of the coating agent composition.

### Silicone Elastomer Particles A3

The coating agent compositions according to the invention further contain silicone elastomer particles A3 in binder component A. Within the scope of this invention, the silicone elastomer particles are included in the binders. The silicone elastomer particles A3 to be used according to the invention are preferably core-shell particles. According to the IUPAC definition, core-shell particles consist of at least two phases. Core-shell systems are composed of an inner part, the so-called core, and an outer part, the so-called shell.

The silicone elastomer particles A3 preferably have a core containing cross-linked polysiloxane and a shell that has reactive groups. The core preferably is a cross-linked polyorganosiloxane which contains dialkylsiloxane repeating units, the term alkyl denoting a C₁- to C₁₈-radical. The core preferably contains dimethylsiloxane repeating units. The reactive groups of the shell preferably contain epoxy groups, ethylenically unsaturated groups and/or hydroxyl groups. Particularly preferably, the reactive groups of the shell contain hydroxyl groups.

The silicone elastomer particles A3 preferably are present in the coating agent compositions according to the invention in an amount of from 0.2 to 9% by weight, particularly preferably in an amount of from 3 to 7% by weight, based on the total weight of the coating agent composition.

A reduction in the percent by weight fraction of the silicone elastomer particles A3 in the total weight of the coating agent composition leads to impaired chemical resistance of the resulting coatings. The reduced chemical resistance of the coating manifests itself in an increased tendency to subsurface migration, which is noticeable by detachment of the coating during the chemical milling process.

The silicone elastomer particles A3 preferably have a volume particle size with a D₅₀ value in the range of from 0.05 to 5 μm, preferably from 0.1 to 3 μm. The particle size of silicone elastomer particles can generally be determined by static light scattering (laser diffraction) in accordance with ISO 13320:2009-10.

The silicone elastomer particles A3 are particularly preferably dispersed in a polyether polyol component A1 of poly(oxyalkylene) glycol. It is most particularly preferred if propoxylated trimethylolpropane A1.3 is used as the dispersing medium. In this most particularly preferred embodiment, the dispersion contains between 20 and 60% by weight, preferably between 35 and 45% by weight, dispersed silicone elastomer particles, based on the total weight of the dispersion.

Suitable commercially obtainable products of this particularly preferred embodiment are obtainable from Evonik under the product line Albidur®.

### Polyurethane Urea A4

As a further constituent, the coating agent compositions according to the invention contain at least one polyurethane urea A4 in binder component A.

The polyurethane urea A4 preferably is present in the coating agent compositions according to the invention in an amount of from 0.5 to 11% by weight, particularly preferably in an amount of from 3 to 8% by weight, based on the total weight of the coating agent composition.

The use of a polyurethane urea A4 in the coating agent compositions according to the invention is essential for the chemical resistance of the resulting coating. A reduction of the percent by weight content of polyurethane urea in the coating agent composition leads to reduced chemical resistance of the coating according to the invention in chemical milling baths, as a result of which the coatings may be detached from the coated substrate.

In a most particularly preferred embodiment, formulations are used in which the polyurethane urea A4 is present in a polyether polyol component A1 of poly(oxyalkylene) glycol. It is most particularly preferred if the polyurethane urea A4 is present in the polypropylene glycol A1.2. In this most particularly preferred embodiment, the mixture of polypropylene glycol A1.2 and polyurethane urea A4 contains between 20 and 40% by weight, preferably between 18 and 22% by weight, polyurethane urea A4, based on the total weight of this formulation.

Suitable commercially obtainable products of this most particularly preferred embodiment of A4 are obtainable from Bayer Material Science under the product line Desmophen®.

### Curing Agent Component B

The coating agent compositions according to the invention contain at least one curing agent component B, wherein the curing agent component B has at least one urethane-group-containing component containing unblocked isocyanate groups B1 and at least one aromatic diisocyanate of methylene di(phenyl isocyanate) B2. According to the invention, the curing agent component B has a content of unblocked isocyanate groups of from 10 to 30% by weight, preferably from 15 to 30% by weight.

The curing agent component B preferably is present in the coating agent compositions according to the invention in an amount of from 20 to 40% by weight, particularly preferably in an amount of from 24 to 32% by weight, based on the total weight of the coating agent composition.

The urethane-group-containing component B1 of the curing agent mixture B preferably is prepared by reacting a hydroxyl-group-containing component B1.1 with an isocyanate component B1.2. The hydroxyl-group-containing component B1.1 preferably is a polyether polyol component of poly(oxyalkylene) glycol. Preferably, poly(oxyalkylene) glycols of ethylene oxide and/or propylene oxide are used. Component B1.1 particularly preferably is an ethoxylated polypropylene glycol. Suitable commercially obtainable products are obtainable from Bayer Material Science under the product line Desmophen®.

The isocyanate component B1.2 for preparing the urethane-group-containing compound B1 preferably is an aromatic diisocyanate, preferably an aromatic diisocyanate of methylene di(phenyl isocyanate).

In the preparation of the urethane-group-containing compound B1 containing free isocyanate groups, the ratio of the OH groups of component B1.1 to the NCO groups of component B1.2 preferably is chosen such that for the ratio OH:NCO, OH<NCO applies. The ratio OH:NCO preferably is in a range of from 1:1.05 to 1:2.05. The ratio OH:NCO particularly preferably is 1:2. The excess of NCO groups in relation to the OH groups has the result that the urethane-group-containing component B1 carries unblocked NCO groups which are available for the later cross-linking reactions with the binder component A. It is particularly preferred for all the OH groups of component B1.1 to have reacted with the isocyanate groups of component B1.2 to form urethane groups, so that the urethane-group-containing component B1 does not have OH groups.

Preferably, the urethane-group-containing compound B1 has a weight-average molecular weight M_{w} of from 4,000 to 6,000 g/mol, particularly preferably from 2,000 to 3,000 g/mol.

For the preparation of the urethane-group-containing component B1 most particularly preferably as the isocyanate component B1.2 there is used the aromatic diisocyanate of methylene di(phenyl isocyanate) B2, which is contained according to the invention in the curing agent component B.

According to the invention, the curing agent component B contains, in addition to component B1, at least one aromatic diisocyanate of methylene di(phenyl isocyanate) B2. The aromatic diisocyanate B2 preferably is 2,2′-diphenylmethane diisocyanate or 2,4′-diphenylmethane diisocyanate or a combination thereof.

The curing agent component B preferably contains from 30 to 80% by weight, particularly preferably from 40 to 70% by weight, of the aromatic diisocyanate of methylene di(phenyl isocyanate) B2.

The curing agent component B can be prepared by first synthesizing the urethane-group-containing component B1. In the next step, the aromatic diisocyanate of methylene di(phenyl isocyanate) B2 of component B1 is added, in order thus to prepare the curing agent component B.

In the most particularly preferred embodiment, in which component B1.2 is identical with component B2, the preparation of the curing agent component B is carried out by direct mixing of the hydroxyl-group-containing compound B1.1 with the aromatic diisocyanate of methylene di(phenyl isocyanate) B2. Upon mixing of the components, the OH groups react with the NCO groups to form the urethane-group-containing component B1 containing unblocked isocyanate groups. In this most particularly preferred embodiment, the initial ratio of the OH groups of component B1.1 to the NCO groups of component B2 is in a range of from 0.5:4 to 1.5:4, preferably from 0.8:4 to 1.2:4.

Based on the coating agent compositions according to the invention, it is further preferred for the ratio of the hydroxyl groups of all the components of the binder component A to the isocyanate groups of the curing agent component B OH:NCO to be in a range of from 1:0.9 to 1:1.4; the ratio is particularly preferably 1:1.1.

If there is an excess of OH groups in comparison with the isocyanate groups in the coating agent composition, the tendency of the resulting coating to subsurface migration increases. The excess of isocyanate groups results in a reduced tendency of the coating to subsurface migration. However, if the excess of isocyanate groups exceeds the ratio described above, the removability of the resulting coating decreases by an increase in the adhesion to the substrate.

### Further Constituents of the Coating Agent Composition

### Pigments and Fillers

According to DIN EN ISO 4618, pigments are dyes consisting of fine particles which are insoluble in the liquid phase of the coating material and are used on account of their optical, protective and/or decorative properties. The term dye here includes black or white dyes. Preferred pigments are color-imparting pigments and/or effect pigments and anticorrosion pigments. Effect pigments are understood as being those which produce an optical effect which is based in particular on light reflection. Typical effect pigments within the meaning of this application are pigments having a high chemical and thermal resistance.

Fillers, on the other hand, according to DIN EN ISO 4618 are materials in granular or powder form which are insoluble in the liquid phase of a coating material and are used to achieve or to influence particular physical properties. Because pigments and fillers can overlap in terms of their intended use, the refractive index is frequently used to distinguish them. In the case of fillers, the refractive index is below 1.7, and this product class therefore does not achieve an appreciable scattering and covering capacity. However, a distinction is not absolutely essential within the scope of the present invention.

Pigments are preferably used in the coating agent compositions according to the invention in order to dye the binder component A and the curing agent component B and thus have visual mixture control during application. When choosing the pigments, their chemical resistance towards the chemicals of the chemical milling bath is preferably taken into consideration.

Preferred pigments are based on a (mono)azo grouping (—N═N—) and preferably have a yellow color. The pigment C.I. Pigment Yellow 74, for example, can be used for this purpose. Particularly preferred pigments have a black color and are based on organic carbon black. The pigment C.I. Pigment Black 7, for example, can be used for this purpose. Further typical pigments which can be used in the coating agent composition according to the invention are white pigments such as, for example, titanium dioxide in rutile form or blue pigments based on copper phthalocyanine.

Low-alkali borosilicate glass in the form of hollow microspheres is preferably used as a filler. The preferred use of hollow microspheres in the coating compositions according to the invention contributes towards improving the visibility of blade cuts. Talcum, mica, barium sulfate, silicate-based components as well as quaternary alkylammonium clay can further be used as fillers in the coating agent composition according to the invention.

### Further Constituents

The coating agent compositions according to the invention can comprise further binders in addition to the binders that are already present. These further binders include, for example, typical coating additives such as deaerating agents of polysiloxanes, adhesion promoters of glycidoxypropyltrimethoxysilanes, rheological additives such as thixotropic agents, and catalysts of amine, tin, diazabicyclooctane and/or zinc, zirconium and aluminum compounds. The coating agent compositions according to the invention can also contain molecular sieves of zeolites, which are included among the fillers.

Particularly preferably, the coating agent compositions according to the invention contain catalysts of zirconium, tin and/or zinc complexes and/or bismuth salts and/or aluminum compounds, which are capable of catalyzing the reaction between hydroxyl and isocyanate groups.

In a further particularly preferred embodiment, the coating agent compositions according to the invention contain, based on the total mass of the coating agent composition, from 0.05 to 0.15% by weight, preferably from 0.08 to 0.10% by weight, deaerating agents, from 0.10 to 1.00% by weight, preferably from 0.20 to 0.50% by weight, adhesion promoters, from 0.01 to 0.40% by weight, preferably from 0.04 to 0.23% by weight, rheological additives, from 0.01 to 5.00% by weight, preferably from 1.50 to 2.50% by weight, molecular sieves, and from 0.10 to 1.00% by weight, preferably from 0.35 to 0.45%, catalysts.

### Process According to the Invention for Producing a Peelable Coating Film

The present invention further provides a process for producing a peelable coating film, obtainable by applying a coating agent composition according to the invention to a metal substrate or plastic substrate.

The substrate preferably is a metal substrate, particularly preferably substrates of aluminum and/or aluminum alloys.

According to EN ISO 4618:2006 (as at April 2007), a peelable coating is defined as a coating material which can be removed again by peeling from a substrate to which it has been applied as temporary protection. Accordingly, a peelable coating film is a coating which can be removed from a substrate again by peeling. The term peeling in this context describes the residue-free removal of a coating from a substrate by the action of a mechanical tensile force. Preferably, residue-free removal of the coating takes place in one piece upon peeling.

In order to produce a peelable coating film according to the invention, the coating agent composition according to the invention is applied to a metal substrate or to a plastic substrate in a wet film thickness of from 100 to 600 μm, preferably from 150 to 450 μm, in a one-coat spraying operation. The coating agent composition is preferably applied by means of a 2-component unit, in which the binder component A and the curing agent component B are supplied separately to the application unit. The two components A and B are preferably not mixed until they are in the application unit. For example, an airless spray gun with an integrated static mixer unit can be used for this purpose. The coating agent composition according to the invention is preferably applied at temperatures of from 20 to 80° C. Application temperatures above ambient temperature are achieved by heating the application unit and optionally by heating the storage container.

After application of the coating agent composition according to the invention to a substrate, chemical cross-linking of the binder component A with the curing agent component B takes place. Chemical cross-linking is carried out at temperatures of from 15 to 60° C., preferably at from 15 to 25° C.

On account of the high solids content of the coating agent compositions according to the invention, the volume shrinkage upon curing of the coating agent composition can be regarded as negligible. The volume shrinkage lies within the margin of error of the determination of the corresponding film thicknesses. Film thickness determinations of the cured coating agent composition are carried out by means of a modular film thickness measuring system from Qnix®8500.

The present invention further provides the use of the coating agent composition according to the invention for producing a peelable and chemically resistant coating for metal substrates and/or plastic substrates, preferably metal substrates, particularly preferably substrates of aluminum and/or aluminum alloys. The aluminum alloys are preferably wrought alloys. The coating is preferably used for protecting substrates in chemical milling baths for thinning out components in aircraft construction.

The present invention further provides a substrate made of one or more metals and/or plastic materials which is coated with a chemically cross-linked coating agent composition according to the invention or has been obtained by the process according to the invention for producing a peelable coating film.

The invention further provides a process for the chemical milling of metal substrates, wherein there is first produced according to the invention a peelable coating film which partially coats the metal substrate, and then the substrate partially coated with the peelable coating film is immersed in a chemical milling bath. Preferred substrates are substrates of aluminum and/or aluminum alloys. The substrate particularly preferably is a component for aircraft construction. The chemical milling baths can be alkaline or acidic milling baths. The partial coating of the metal substrate can be achieved by covering regions that are not to be coated or by applying a peelable coating film which initially covers the metal substrate completely, followed by partial removal of this peelable coating film.

The invention will be explained in greater detail below by means of examples.

Unless otherwise indicated, data in parts are parts by weight and data in percent are percent by weight.

### Preparation of Examples BM1 to BM6 According to the Invention of Binder Component A

TABLE 1
Composition of embodiments BM1 to BM3

| Binder component A | | | |
|---|---|---|---|
| Charge | BM1 | BM2 | BM3 |
| Propoxylated polyethylene glycol A1.1 | 13.75 | 13.75 | 13.75 |
| Formulation of propylene glycol A1.2 | 11.00 | 11.00 | 11.00 |
| containing 20% by weight polyurethane | | | |
| urea A4, based on the formulation | | | |
| 40% by weight silicone elastomer | 10.00 | 20.00 | 10.00 |
| dispersion containing 40% by weight | | | |
| silicone elastomer particles A3 in | | | |
| propoxylated trimethylolpropane A1.3 | | | |
| Modified polyamide thickener | 0.10 | 0.10 | 0.10 |
| Organomodified mineral thickener | 0.35 | 0.35 | 0.35 |
| Filler containing chlorite, mica and quartz | 5.50 | 5.50 | 5.50 |
| Molecular sieve as moisture trap | 4.00 | 4.00 | 4.00 |
| Propoxylated polyethylene glycol A1.1 | 20.00 | 10.00 | 16.00 |
| Organic catalyst | 0.28 | 0.28 | 0.28 |
| Accelerator 2 containing | 0.24 | 0.24 | 0.24 |
| diazabicyclooctane and tris(dimethyl- | | | |
| aminopropylamine) | | | |
| Metal complex catalyst based on zinc | 0.28 | 0.28 | 0.28 |
| Aromatic diamine A2 | 6.00 | 6.00 | 10.00 |
| Silicone-containing antifoam | 0.10 | 0.10 | 0.10 |
| Formulation of propylene glycol A1.2 | 26.00 | 26.00 | 26.00 |
| containing 20% by weight polyurethane | | | |
| urea A4, based on the formulation | | | |
| gamma-Glycidoxy-propyltrimethoxysilane | 0.40 | 0.40 | 0.40 |
| Hollow microspheres | 2.00 | 2.00 | 2.00 |
| Total binder component A | 100.00 | 100.00 | 100.00 |

TABLE 2
Compositions of embodiments BM4 to BM6

| Binder component A | | | |
|---|---|---|---|
| Charge | BM4 | BM5 | BM6 |
| Propoxylated polyethylene glycol A1.1 | 13.75 | 13.75 | 13.75 |
| Formulation of propylene glycol A1.2 | 21.00 | 11.00 | 11.00 |
| containing 20% by weight polyurethane | | | |
| urea A4, based on the formulation | | | |
| 40% by weight silicone elastomer | 10.00 | 20.00 | 10.00 |
| dispersion containing 40% by weight | | | |
| silicone elastomer particles A3 in | | | |
| propoxylated trimethylolpropane A1.3 | | | |
| Modified polyamide thickener | 0.10 | 0.10 | 0.10 |
| Organomodified mineral thickener | 0.35 | 0.35 | 0.35 |
| Filler containing chlorite, mica and quartz | 5.50 | 5.50 | 5.50 |
| Molecular sieve as moisture trap | 4.00 | 4.00 | 4.00 |
| Propoxylated polyethylene glycol A1.1 | 10.00 | 10.00 | 19.40 |
| Organic catalyst | 0.28 | 0.28 | 0.28 |
| Accelerator 2 containing | 0.24 | 0.24 | 0.24 |
| diazabicyclooctane and tris- | | | |
| (dimethylaminopropylamine) | | | |
| Metal complex catalyst based on zinc | 0.28 | 0.28 | 0.28 |
| Aromatic diamine A2 | 6.00 | 6.00 | 10.00 |
| Silicone-containing antifoam | 0.10 | 0.10 | 0.10 |
| Formulation of propylene glycol A1.2 | 26.00 | 26.00 | 26.00 |
| containing 20% by weight polyurethane | | | |
| urea A4, based on the formulation | | | |
| gamma-Glycidoxy-propyltrimethoxysilane | 0.40 | 0.40 | 1.00 |
| Hollow microspheres | 2.00 | 2.00 | 2.00 |
| Total binder component A | 100.00 | 100.00 | 100.00 |

The binder components A according to the invention are prepared by first mixing the components listed in Tables 1 and 2 under “Charge” in the above sequence. Dispersion is then carried out to a temperature of 55° C. When that temperature has been reached, all the further components are added, with stirring. When the addition is complete, stirring is continued for a further 15 minutes. After a maturing time of at least 12 hours, the binder components are ready for use.

### Preparation of Examples H1 to H3 According to the Invention of Curing Agent Component B

TABLE 3
Composition of curing agent component B: H1 to H3

| Curing agent component B | H1 | H2 | H3 |
|---|---|---|---|
| Methylene di(phenyl isocyanate) isomer | 70.62 | 62.62 | 81.62 |
| mixture B1.2 and B2 | | | |
| Poly(oxyalkylene glycol) of ethylene | 28.4 | 36.4 | 18.4 |
| oxide/propylene oxide B1.1 | | | |
| gamma-Glycidoxy-propyltrimethoxysilane | 0.5 | 1.0 | 0.8 |
| Pigment paste black | 0.4 | | 0.4 |
| Pigment paste yellow | | 0.6 | |
| Silicone-containing antifoam | 0.08 | 0.1 | 0.08 |
| Total curing agent component B | 100.00 | 100.00 | 100.00 |

For the preparation of the curing agent components B, the methylene di(phenyl isocyanate) isomer mixture is presented and the remaining components are added in the indicated sequence, with stirring. The subsequent reaction time is from 1 to 12 hours.

### Preparation of Coating Compositions C1 to C4 According to the Invention

The coating agent composition according to the invention is prepared by mixing 100 parts by weight of binder component A with 40 parts by weight of curing agent component B. The following coating agent compositions were prepared: BM1 with H1 (C1), BM1 with H3 (C2), BM2 with H1 (C3) and BM6 with H1 (C4).

### Preparation of a Coating Agent Composition (Comparison) VC1

A coating agent composition was prepared analogously to formulation 1 of WO 97/35932 as a comparative example.

### Production of the Peelable Coating Films

In order to produce peelable coating films SC1 to SC4 and SVC1, the coating agent compositions described above were applied to both sides of aluminum test sheets of alloy 2024, non-plated, by means of a two-component high-pressure spraying unit, the storage container and hose system of which can be adjusted in terms of temperature. The dry film thickness was in the range of from 250 to 450 μm. This was determined 30 minutes after application.

### Results

Testing of the chemical resistance and the tendency to subsurface migration was carried out by the process described below.

After a drying time of two hours, a first, so-called “tensile adhesion value” was determined on each test sheet in order to determine, in grams, the tensile adhesive force that is necessary to remove a 1 cm wide coating strip from the substrate. These values indicate the level of force required to demask a component. Cut-outs are also obtained thereby, and these are used later after the pickling operations to assess the resistance of the coating to subsurface migration. The determination of a tensile adhesive force is carried out a total of four times and is described by way of example below:

A coating strip measuring 10×1 cm was cut with a sharp blade. This region was removed. This served to ensure that the actual test area in the later adhesion test definitely has no erroneous measurements, on account of any cutting lines that are not pervasively deep. The first 10 mm of the coating strip that remains are then lifted by means of the blade used for cutting, in order to form a fixing point for the spring balance which is later to be attached. A retaining clip is then applied transversely across the width of the area at that fixing point, in order to prevent the spring balance from slipping. A previously calibrated spring balance is then attached to the retaining clip by means of a toothed clamp. The spring balance is then oriented at a 45° angle to the substrate. As soon as the spring balance has assumed the correct angle, the coating strip is peeled off the substrate within 3 seconds using the spring balance. In parallel, the force necessary therefor is read off from the scale of the spring balance.

After the first tensile adhesion value has been determined on each test sheet, the test sheets are transferred to a sodium hydroxide bath (16% by weight sodium hydroxide in 84% demineralized water) previously heated to 70° C., and chemically milled therein for 10 minutes. The test sheets are then transferred to a water bath in order to wash off the lye residues. The dwell time in the water bath was 2 minutes.

Ten minutes after the first milling step, a tensile adhesion value was again determined on each test panel. A second pickling step was then carried out.

For the second pickling step, the test sheets were again transferred to the already described sodium hydroxide bath and remained in the bath for from 25 to 30 minutes. After this time, rinsing is again carried out for two minutes in the water bath. Following rinsing, the samples are removed from the water for 30 seconds. This simulates dripping processes in later use and ensures that no or only very small amounts of water are introduced into the following nitric acid bath.

After the lifting phase, the test panels are neutralized in a nitric acid bath. The neutralization phase is exactly 70 seconds and is then again terminated with a 30-second lifting phase. This lifting is followed by a further two-minute dwell time in the water bath. Four minutes after leaving the water bath, the third tensile adhesion value was determined as described. 18 hours after the determination of the third tensile adhesion value, the fourth tensile adhesion value is determined. This simulates storage of already milled components overnight prior to a demasking process. During this dwell time, the milled edges of the aluminum can be assessed at the window regions which were exposed in the demasked state to the sodium hydroxide milling bath.

TABLE 3
Results of the tensile adhesion test

| | Total |
|---|---|
| SC1 | |
| Tensile adhesion AL 2024 2 h after application | 150-410 g |
| Tensile adhesion AL 2024 after 10 min pickling | 130-400 g |
| Tensile adhesion AL 2024 after 30 min pickling | 160-450 g |
| Tensile adhesion AL 2024 18 h after last pickling step | 250-530 g |
| SC2 | |
| Tensile adhesion AL 2024 2 h after application | 250-400 g |
| Tensile adhesion AL 2024 after 10 min pickling | 230-400 g |
| Tensile adhesion AL 2024 after 30 min pickling | 270-450 g |
| Tensile adhesion AL 2024 18 h after last pickling step | 330-500 g |
| SC3 | |
| Tensile adhesion AL 2024 2 h after application | 150-390 g |
| Tensile adhesion AL 2024 after 10 min pickling | 150-420 g |
| Tensile adhesion AL 2024 after 30 min pickling | 190-470 g |
| Tensile adhesion AL 2024 18 h after last pickling step | 280-540 g |
| SC4 | |
| Tensile adhesion AL 2024 2 h after application | 220-410 g |
| Tensile adhesion AL 2024 after 10 min pickling | 200-400 g |
| Tensile adhesion AL 2024 after 30 min pickling | 230-420 g |
| Tensile adhesion AL 2024 18 h after last pickling step | 310-500 g |

The tendency of the peelable coating films produced from the coating agent compositions according to the invention to subsurface migration is below 2 mm. In the case of the peelable coating films produced from the coating agent compositions not according to the invention, discontinuous subsurface migration incursions of from 2 to 5 mm are found.

1. A coating agent composition containing at least one binder component A and
at least one curing agent component B,
the binder component A containing
A1 at least one polyether polyol component of poly(oxyalkylene) glycol,
A2 at least one aromatic diamine,
A3 silicone elastomer particles and
A4 at least one polyurethane urea,
the curing agent component B containing
B1 at least one urethane-group-containing component containing unblocked isocyanate groups and
B2 at least one aromatic diisocyanate of methylene di(phenyl isocyanate),
wherein the curing agent component B has a content of unblocked isocyanate groups of from 10 to 30% by weight and
wherein the solids content of the coating agent composition is greater than 95% by weight.

2. The coating agent composition according to claim 1, wherein
component A1 is present in an amount of from 8 to 76% by weight,
component A2 is present in an amount of from 1 to 8% by weight,
component A3 is present in an amount of from 0.2 to 9% by weight,
component A4 is present in an amount of from 0.5 to 11% by weight, and
the curing agent component B is present in an amount of from 20 to 40% by weight,
in each case based on the total weight of the coating agent composition.

3. The coating agent composition according to claim 1, wherein the polyether polyol component A1 of poly(oxyalkylene glycol) contains at least one poly(oxyalkylene) glycol of ethylene oxide and/or propylene oxide.

4. The coating agent composition according to claim 3, wherein the polyether polyol component A1 comprises at least one propoxylated polyethylene glycol A1.1, at least one polypropylene glycol A1.2 and at least one propoxylated trimethylolpropane A1.3.

5. The coating agent composition according to claim 1, wherein the urethane-group-containing component B1 is the reaction product of a hydroxyl-group-containing component B1.1 with an isocyanate component B1.2, wherein the hydroxyl-group-containing component B1.1 is a polyether polyol component of poly(oxyalkylene) glycol, the isocyanate component B1.2 is an aromatic diisocyanate of methylene di(phenyl isocyanate), and the ratio of the OH groups of component B1.1 to the NCO groups of the isocyanate component B1.2 is in a range of from 1:1.05 to 1:2.05.

6. The coating agent composition according to claim 1, wherein the fraction of component B2, based on the curing agent component B, is from 40 to 60% by weight.

7. The coating agent composition according to claim 1, wherein the aromatic diamine A2 is a mononuclear aromatic compound, the aromatic diamine A2 is alkylated, and the amine groups are bonded directly to the aromatic compound.

8. The coating agent composition according to claim 1, wherein the silicone elastomer particles are core-shell particles which have a core containing cross-linked polysiloxane and a shell having the reactive groups.

9. The coating agent composition according to claim 1, wherein the solids content of the coating agent composition is greater than 97% by weight.

10. The coating agent composition according to claim 1, wherein it comprises low-alkali borosilicate glass in the form of hollow microspheres as filler.

11. A process for producing a peelable coating film obtainable by applying a coating agent composition according to claim 1 to a metal substrate and/or plastic substrate with a wet film thickness of from 100 to 600 μm, in a one-coat spraying operation and then curing by chemical cross-linking in a temperature range of from 15 to 60° C.

12. A process for chemically milling metal substrates, comprising i) producing a peelable coating film according to claim 11 which partially coats the metal substrate, wherein the partial coating with the peelable coating film is achieved either by previously covering regions that are not to be coated or by first applying to the substrate a peelable coating film which completely covers the substrate and which is subsequently partially removed, and ii) immersing the substrate partially coated with the peelable coating film in an alkaline or acidic chemical milling bath.

13. (canceled)

14. (canceled)

15. A substrate made of one or more metals and/or plastic materials which is coated with a chemically cross-linked coating agent composition according to claim 1 or has been obtained by the process according to claim 11.

16. A substrate made of one or more metals and/or plastic materials obtained by the process according to claim 11.

17. The coating agent composition according to claim 1, wherein the solids content of the coating agent composition is greater than 99% by weight.

18. The process according to claim 11, wherein
component A1 is present in an amount of from 8 to 76% by weight,
component A2 is present in an amount of from 1 to 8% by weight,
component A3 is present in an amount of from 0.2 to 9% by weight,
component A4 is present in an amount of from 0.5 to 11% by weight, and
the curing agent component B is present in an amount of from 20 to 40% by weight,
in each case based on the total weight of the coating agent composition.

19. The process according to claim 11, wherein
(i) the polyether polyol component A1 of poly(oxyalkylene glycol) contains at least one poly(oxyalkylene) glycol of ethylene oxide and/or propylene oxide;
(ii) the polyether polyol component A1 comprises at least one propoxylated polyethylene glycol A1.1, at least one polypropylene glycol A1.2 and at least one propoxylated trimethylolpropane A1.3; or
(iii) the aromatic diamine A2 is a mononuclear aromatic compound, the aromatic diamine A2 is alkylated, and the amine groups are bonded directly to the aromatic compound.

20. The process according to claim 11, wherein the urethane-group-containing component B1 is the reaction product of a hydroxyl-group-containing component B1.1 with an isocyanate component B1.2, wherein the hydroxyl-group-containing component B1.1 is a polyether polyol component of poly(oxyalkylene) glycol, the isocyanate component B1.2 is an aromatic diisocyanate of methylene di(phenyl isocyanate), and the ratio of the OH groups of component B1.1 to the NCO groups of the isocyanate component B1.2 is in a range of from 1:1.05 to 1:2.05.

21. The process according to claim 12, wherein
(iv) the polyether polyol component A1 of poly(oxyalkylene glycol) contains at least one poly(oxyalkylene) glycol of ethylene oxide and/or propylene oxide;
(v) the polyether polyol component A1 comprises at least one propoxylated polyethylene glycol A1.1, at least one polypropylene glycol A1.2 and at least one propoxylated trimethylolpropane A1.3; or
(vi) the aromatic diamine A2 is a mononuclear aromatic compound, the aromatic diamine A2 is alkylated, and the amine groups are bonded directly to the aromatic compound.

22. The process according to claim 12, wherein the urethane-group-containing component B1 is the reaction product of a hydroxyl-group-containing component B1.1 with an isocyanate component B1.2, wherein the hydroxyl-group-containing component B1.1 is a polyether polyol component of poly(oxyalkylene) glycol, the isocyanate component B1.2 is an aromatic diisocyanate of methylene di(phenyl isocyanate), and the ratio of the OH groups of component B1.1 to the NCO groups of the isocyanate component B1.2 is in a range of from 1:1.05 to 1:2.05.
